(19) United States
(12) Patent Application Publication
(10) Pub. No.: US 2017/0174179 A1
(43) Pub. Date: Jun. 22, 2017

(54) Assembly Module for a Motor Vehicle

(71) Applicant: Huf Hülsbeck & Fürst GmbH & Co. KG, Velbert (DE)

(72) Inventors: Helmut SCHUMACHER, Coesfeld (DE); Mirko SCHINDLER, Velbert (DE); Norbert HELLER, Grefrath (DE); Oliver MÜLLER, Velbert (DE); Bernd ETTE, Wolfsburg (DE); Nadine STICHERLING, Essen (DE); Alexander ZIEGLER, Wülfrath (DE); Jean MALABO YOMKIL, Essen (DE); Stefan MÖNIG, Schwelm (DE); Iko LINDIC, Essen (DE); Christof HACHE, Velbert (DE)

(21) Appl. No.: 15/115,523

(22) PCT Filed: Jan. 7, 2015
(86) PCT No.: PCT/DE2015/100006

§ 371 Date: Jul. 29, 2016

(30) Foreign Application Priority Data
Jan. 31, 2014 (DE) 10 2014 101 201.1

(51) Int. Cl. B60R 25/24; B60R 25/10; B60R 16/023; B60R 16/037; B60D 1/42; B60Q 1/24; B60R 25/01; E05F 15/73

(52) U.S. Cl. CPC B60R 25/24; B60R 25/01; B60R 25/1004; E05F 15/73; B60R 16/037; B60D 1/42; B60Q 1/24; B60R 16/0231; E05F 2015/765; E05Y 2900/531; E05Y 2900/534; E05Y 2900/536; E05Y 2900/55; E05Y 2900/546

(57) ABSTRACT

The invention relates to an assembly module (20) for a motor vehicle (1), comprising an optical sensor system (30) which can be used a) to monitor a detection area (150) on the outside of the motor vehicle (1) in order to determine the proximity of a user (10), b) to emit a flash of laser light within the detection area (150), c) to detect a reflection of the flash of laser light (122) from the user (10) and d) to release a signal for carrying out an action on the motor vehicle (1) in the event a user (10) is detected in a predefined actuation area (180) within the detection area (150).

The present invention pertains to an assembly module for a motor vehicle, as well as to a method for triggering a signal for carrying out an action on a motor vehicle.

It is known that the surroundings of vehicles can be monitored in order to carry out actions on the vehicles. In this respect, for example, so-called “keyless entry” and “keyless go” functions are used in vehicles. In this case, a corresponding radio transmitter key, e.g. in the trouser pocket of a user, is detected when it is located in the vicinity of the vehicle, e.g. by means of radio monitoring. Subsequently, an action in the form of an authentication may be carried out, during which it can be determined if the key matches the vehicle by means of an inquiry. The vehicle can then be unlocked or locked. Other monitoring methods, e.g. capacitive methods, are also known. In this context, it is possible to detect, for example, when a hand of the user reaches into the door handle by means of capacitive sensors. This may also trigger an action such as, e.g., the authentication of the user based on the corresponding radio transmitter key carried along by the user.

Known solutions have the disadvantage that they always require active triggering or an active start. For example, the authentication is only triggered by the capacitive sensor when the user actually reaches for the door handle of the vehicle. The same applies to automatically opening the tailgate, which only takes place when the user is located sufficiently close to the vehicle and a corresponding sensor system. In addition, known methods are not sufficiently sensitive such that a gesture or a user is basically at risk of being misinterpreted.

The present invention is based on the objective of at least partially eliminating the above-described disadvantages. The present invention particularly aims to reduce or completely eliminate the risk of spuriously triggering a corresponding signal for carrying out an action on the motor vehicle in a simple and cost-effective fashion.

The above-defined objective is attained by means of an assembly module with the characteristics of claim 1, as well as a method with the characteristics of claim 18. Other details and characteristics of the invention can be gathered from the dependent claims, the description and the drawings. In this respect, characteristics and details described in connection with the inventive assembly module naturally also apply to the inventive method and vise versa such that mutual reference is or can always be made with respect to the disclosure of the individual aspects of the invention.

An inventive assembly module for a motor vehicle with an optical sensor system is suitable for carrying out the following steps:
a) monitoring a detection area located outside the motor vehicle in order to detect the proximity of a user
b) emitting a laser light flash within the detection area,
c) detecting a reflection of the laser light flash by the user, and
d) triggering a signal for carrying out an action on the motor vehicle in case the user is detected in a predefined actuation area within the detection area.

According to the invention, the assembly module may be mounted on the motor vehicle. In this context, an optical sensor system refers to a system that features one or more sensor units. Optical monitoring of the detection area can be carried out with these sensor units. For example, the sensor system may comprise a photosensor that features individual photosensitive pixels. In this way, an image of the detection area, particularly a two-dimensional image, can be generated and changes of the individual pixels during a monitoring sequence can be attributed to a user who enters the detection area. In other words, the detection area can now be monitored in a purely optical and, in particular, continuous fashion.

In the context of the present invention, a detection area is an area located adjacent to or outside the vehicle, in which a user intention for a subsequent action is expected with high probability. For example, such a detection area may be arranged behind the vehicle and imply an action with respect to the tailgate, e.g. the intention to open the tailgate. It is also possible to realize a corresponding detection area adjacent to the vehicle, e.g. in the region of the driver's door or the rear doors, particularly in the region of a sliding door. When the user enters this detection area, this would almost certainly imply the intention to actuate the corresponding door.

According to the invention, there is a distinction between the detection area and the actuation area. The actuation area is arranged within the detection area and preferably smaller, particularly much smaller, than the detection area. Consequently, a two-stage detection is essentially carried out. According to the invention, the detection area is preferably monitored continuously and therefore constantly. This makes it possible to detect when a user enters the detection area. At this point and preferably also only after this point, the smaller actuation area within the detection area is monitored. In other words, the inventive optical sensor system is in a basic monitoring mode with respect to the detection area. The laser light flash can be emitted in this monitoring mode or in dependence on the entry of the user into the detection area in order to allow a correlation with the predefined actuation area.

According to the invention, the utilization of a laser light flash is essential, in particular, for additionally acquiring distance information with respect to the user. According to the present invention, the laser light flash therefore can be used for obtaining three-dimensional information by detecting its reflection. The basic optical sensor system operates, e.g., with the aid of a photosensor whereas the laser light flash can add three-dimensional distance information to the two-dimensional information of such a photosensor. This makes it possible to define the detection area and, in particular, the actuation area with respect to its distance from the vehicle or the assembly module.

The described 3D information may be obtained due to the utilization of a laser light flash. For example, a so-called “time of flight” method (TOF) may be used in this case. In such methods, the time elapsed between the emission of the laser light flash and the reception of its reflection is measured. A distance calculation or a distance determination can then be carried out based on this time difference by means of a correlation with the speed of light. As a result, not only a basic detection of the corresponding user within the detection area or within the actuation area can be realized, but this detection is also correlated with distance information.

With respect to the detection area and the actuation area, the utilization of an inventive laser light flash means that these areas no longer have to be realized two-dimensionally in the form of a surface area outside the vehicle, but that the detection area and the actuation area may also be respectively realized in the form of a detection volume and actuation volume. In this context, it should be noted that the volume of the detection area, as well as the volume of the actuation area, may naturally extend from the ground up to a maximum height. However, it may also be advantageous to specify two or more distance limits that, in a manner of speaking, make it possible to respectively define a volume in the form of a floating detection area or a floating actuation area. This ensures that undesirable standing within the actuation area cannot potentially lead to inadvertent triggering of the action due to the triggering of the signal. Gestures therefore can be recognized and predefined, as well as distinguished from other gestures that should not trigger the action, in an even more distinct fashion. The function of an inventive method and an inventive assembly module is briefly described below with reference to an example.

If the assembly module is located, e.g., in the tail region of the vehicle, it serves for triggering a corresponding signal for automatically opening the tailgate. For this purpose, the detection area located behind the motor vehicle is continuously monitored. If the user enters said detection area, this is detected and, e.g., an authentication step may initially take place. If the user is verified as an authenticated user based on a radio transmission key carried along, e.g., in a trouser pocket, the actuation area can now be actively or passively monitored. If the user or a body part of the user is detected within the actuation area, the signal for carrying out the desired action on the motor vehicle, namely for automatically opening the tailgate, is triggered. In other words, the user initially enters the detection area, whereupon the user or a body part of the user must move into the actuation area in order to trigger the desired signal for carrying out the action on the motor vehicle in a three-dimensional information structure with the aid of the laser light flash.

According to the invention, the security of the method and of the assembly module is significantly increased. In known solutions, false unlocking could potentially take place, for example, if the user of the vehicle is located behind the vehicle with the corresponding radio transmission key, but has no intention to open the tailgate. In this case, the user could accidentally move into the actuation area such that the intention to open the tailgate or the intention to trigger the action is inadvertently detected. Due to the utilization of the inventive laser light flash, 3D information now allows a much stricter confinement of the actuation area, particularly of its height. In this way, the ability to distinguish different gestures is improved such that the above-described false triggering risk is now significantly reduced.

Another advantage of the inventive assembly module can be seen in that the precise determination of the three-dimensional information with the aid of the laser light flash is only required with respect to the actuation area. Consequently, an inventive assembly module makes it possible to implement a two-stage method, in which the laser light flash particularly is not used continuously for the predefined actuation area, but only when the user is detected within the detection area.

In the context of the present invention, a laser light flash refers to any form of wavelengths that is included in the definition of a laser light. A laser light flash is realized if the laser light is not emitted continuously, but only for a very brief period of time that preferably amounts to less than about the second. The laser light flash is preferably emitted multiple times such that it can also be referred to as a pulsed laser light flash. This is likewise described in greater detail further below.

The optical sensor system or the entire assembly module may be designed for being arranged on the tail section of the vehicle, e.g. behind the rear window, in a handle, in an emblem, in a taillight, behind a rear reflector, on a bumper and/or in a gap between two components. The assembly module may alternatively or additionally be suitable for being mounted on a side of the vehicle such as, e.g., in a B-pillar. In this way, different detection areas, in which the user usually approaches the motor vehicle, can be monitored with the optical sensor system. The optical sensor system or the entire assembly module particularly can be concealed behind an externally opaque layer that, however, is transparent to the light of the optical sensor system. For example, a bumper, on which the optical sensor system is mounted, can therefore be painted.

The optical sensor system preferably is arranged on the motor vehicle such that little soiling occurs. For example, the optical sensor system may be arranged behind the rear window in the wiping region of the windshield wiper or on the handle. The assembly module may alternatively or additionally feature a washing nozzle for cleaning the optical sensor system. In this case, the washing nozzle may automatically clean the optical sensor system, for example, when the windshield wiper for the front and/or rear window is actuated. The operation of a clean optical sensor system requires a lower light intensity such that energy savings can thereby also be achieved.

The intensity of the emitted light may depend on the brightness of the ambient light. The brightness of the ambient light can be determined by means of a brightness sensor.

If different user intentions can be detected during the monitoring of the actuation area, different gestures can be assigned to different user intentions. For example, stepping into the actuation area may cause the tailgate to open whereas a lateral motion of a hand near the optical sensor causes the trailer hitch to extend.

It would be conceivable that the removal of an object from the actuation area has to take place within a predefined removal period in order to make available the signal. The removal of an object within a predefined removal period may be part of the gesture. The beginning of the removal period can be perceived by the user. For example, a display element can assume several illumination states. In one of the illumination states, such a display element may emit light of constant brightness. In another illumination state, e.g., the brightness may change periodically. At the beginning of the actuation period, for example, the display element may emit light of constant brightness. The display element may blink during the removal period. The signal is only made available if the object, particularly a body part of the user, is removed from the actuation area within the removal period.

The assembly module and/or the motor vehicle may feature at least one means that makes it easier for the user to express the user intention in the actuation area in order to trigger the signal.

For example, the assembly module may emit an information signal indicating that the actuation period will end shortly. The information signal may begin, e.g., with a change of the illumination state of the display element. The information signal may correspond to another illumination state of the display element. For example, the display element may blink at the end of the actuation period. The means corresponds to a corresponding procedural specification in the monitoring unit.

In order to express a user intention, it may also be helpful to guide the user to the actuation area. This applies, in particular, if the user carries a large object and therefore can no longer perceive the end of the actuation area on the ground. To this end, the assembly module and/or the motor vehicle may feature means for generating a signal that can be perceived by the user, particularly a visible, audible or tactile signal. For example, the assembly module may feature lamps such as LEDs. The lamps can be arranged in such a way that they act as a guidepost. The lamps may be aligned, for example, such that markings leading to the actuation area are generated on the ground. The lamps may alternatively or additionally be arranged adjacent to one another. The lamps can be activated in a sequence that indicates the direction, in which the user has to move in order to reach the actuation area. Instead of the lamps, already existing light elements that are arranged adjacent to one another in the motor vehicle such as, e.g., the lamps of headlights, brake lights, blinkers or the like may also be used for this purpose. It would likewise be conceivable to provide the user with acoustically audible instructions of the required moving direction. In this case, the assembly module may feature a loudspeaker. It would furthermore be conceivable to inform the ID transmitter of the change in direction, wherein the ID transmitter generates different vibrations in order to point the user in the corresponding direction. If the user is informed of a change in direction, the optical sensor system determines the position of the user and the direction, in which the user has to move in order to reach the actuation area, and subsequently prompts the perceivable means to emit the corresponding signal.

It may likewise be helpful to the user that the position of the actuation area and/or the length of the actuation period is variable. This is particularly helpful when a physically handicapped user wants to express a user intention. This is likewise helpful when the actuation area is arranged in an unfavorable position for the user. This unfavorable position may be permanent. For example, the actuation area may end on a trailer hitch. Alternatively, the unfavorable position may only be unfavorable for a unique signal triggering process, e.g., because the actuation area ends at a puddle. A predefined user action may particularly be required in order to change the position of the actuation area and/or the length of the actuation period. For example, the user can change the position of the actuation area and/or the length of the actuation period with a corresponding input in a user menu, e.g., of a motor vehicle control unit or an ID transmitter. The predefined user action may alternatively be detected by the optical sensor system. In another alternative, the assembly module can be transferred into a learning mode, in which the assembly module learns the changed position of the actuation area and/or the changed length of the actuation area.

It may likewise be helpful to the user that the actuation area is monitored anew in order to detect a user intention and thereby trigger an operating signal after a first actuation period has elapsed without the detection of a user intention. This is particularly helpful if the user was distracted and did not reach the actuation area in time or if the user did not make the correct gesture. It is therefore conceivable to successively monitor the actuation area multiple times, particularly two or three times. The repeated monitoring of the actuation area can be automatically initiated. Alternatively, a predefined user action may be required in order to monitor the actuation area anew for another actuation period. This can be achieved, for example, in that a capacitive sensor responds to the user. Alternatively, the predefined user action may be detected by the optical sensor system.

For example, the predefined user action, which is detected by the optical sensor system and causes a change in the position of the actuation area and/or the actuation period and/or the repeated monitoring of the actuation area in order to detect a user intention, may consist of one of the following user actions: a predefined gesticulation within the actuation and/or detection area such as moving a body part of the user back and forth, a non-removal of the body part if its removal was expected or a movement of the user into the detection and/or actuation area and/or out of the detection and/or actuation area. The body part may particularly be a hand or a foot. It would also be conceivable that the user exits the detection area for a predefined period of time and then reenters the detection area.

The display element also indicates when the actuation area is monitored anew in order to detect a user intention. The display element likewise indicates when the position of the actuation area is changed. To this end, the display element may feature several lamps, e.g. LEDs. One or more lamps respectively visualize an actuation area at least partially. The actuation area with the changed position preferably lies within the detection area. The corresponding pixels are evaluated depending on the actuation area being monitored.

A position of the ID transmitter may be checked during or after an authentication and before the signal is triggered. This can be realized by determining the intensity of a signal emitted by the ID transmitter. For example, the Receive Signal Strength Indicator (RSSI) may be used for this purpose. The determination of the intensity of the emitted signal makes it possible to ascertain whether the user is located in front of, adjacent to or behind the motor vehicle. In this way, it can be ensured that only the authorized user himself has reached the detection area and expressed a user intention in the actuation area. It is conceivable to query the RSSI cyclically.

It may be advantageous if the optical sensor system of an inventive assembly module is designed for triggering a signal for starting an authentication check between the ID transmitter and an access control system of the motor vehicle if the user is detected in the detection area and for only carrying out steps b) through d) if the authentication result is positive. This means that the inventive sensor system only carries out its decisive triggering steps with the aid of the laser light flash if the authorized user is actually located within the detection area. It is thereby ensured that the high energy demand for emitting a laser light flash only occurs if the authorized person is actually located at the corresponding position in the detection area. In this embodiment, it is naturally possible to only carry out the authentication step when the vehicle is locked. In an unlocked vehicle, e.g., the front-seat passenger or a person without a radio transmitter module within the trouser pocket may therefore also trigger the corresponding action.

It is furthermore advantageous if the optical sensor system of an inventive assembly module is designed for inhibiting steps b) through d) if no user has been detected in the detection area. Alternatively, steps b) through d) naturally may also be actively allowed or carried out if the user has been detected in the detection area. These two variations make it clear that particularly the energy demand can be significantly reduced. The required precise determination for achieving the inventive reduction of the false triggering risk is only carried out when a user is actually located within the detection area. The low energy demand for monitoring the detection area particularly can be maintained during extended parking situations, in which a vehicle may be located, e.g., in a parking garage of an airport for several days or weeks. The high energy demand required for generating the laser light flashes is therefore prevented during this continuous monitoring and only occurs when the user has actually been detected within the detection area. This embodiment particularly is combined with the authentication check according to the preceding paragraph. This prevents the high energy demand for the laser light flash from occurring every time a person moves through the detection area. The energy demand for the continuous operation of the assembly module is thereby additionally reduced.

According to the invention, it is furthermore advantageous if the optical sensor system of an inventive assembly module features an emitter unit for the emission of the laser light flash with a wavelength in the infrared range, particularly with a wavelength in the range of 905 nm plus/minus about 10 nm. Laser light flashes with a wavelength in the infrared range have the advantage of being invisible to the human eye. Light effects, e.g. in a parking garage, are thereby prevented. This embodiment is also advantageous because an optical perception by the user does not take place and the sensor system therefore is effectively invisible. Last but not least, the utilization of a laser light flash in the infrared range makes it possible to operate independently of the ambient lighting. In this respect, the infrared range is also advantageous because it can be more distinctly and better distinguished from scattered ambient light and reflections of sunlight. The range, in which the laser light flash is emitted, is particularly realized in the form of a wavelength peak that is defined as narrow as possible. In this way, the emitted and reflected laser light flash can also be easily and, in particular, computationally filtered out from a broad spectrum that is perceived as total reflection by the optical sensor device.

Light of different wavelengths likewise makes it possible to save energy. For example, the monitoring of the detection area may up to the unique detection of an arbitrary object in the detection area take place with light of a longer wavelength than the subsequent check of other requirements with respect to the detection of a user. For example, light with a wavelength of 905 nm may initially be used. Once an object is detected in the detection area, for example, light with a wavelength of 800 nm may be used. The wavelength may alternatively become shorter as the object moves from the far zone into the near zone.

Another advantage can be attained if the optical sensor system of an inventive assembly module features an optical filter, particularly an infrared filter, for optically filtering the emitted laser light flash and/or the reflection of the laser light flash. It is preferred that this optical filter is respectively provided only on the emitter unit or only on the receiver unit. This makes it possible to reduce the width of the emitted peak in the wavelength spectrum of the laser light pulse as described in the preceding paragraph. As a result, the emitted laser light flash subsequently can be specifically filtered out of a broad reflection spectrum in a simplified and, in particular, computational fashion. A corresponding filter may naturally also be used on an associated receiver unit. Since such an optical filter makes it possible to reduce the width of the spectrum of the emitted laser light flash with respect to its wavelength, it is possible to use simpler and, in particular, more cost-efficient light sources for the laser light flash.

It is likewise advantageous if the optical sensor system of an inventive assembly module features at least one polarizer for polarizing the emitted laser light flash and/or its reflection. This polarizer may fulfill a function similar to that of the corresponding optical filter described in the preceding paragraph. In this case, the emitted laser light of the laser light flash can also be specified in greater detail in order to subsequently carry out a simpler, faster and, in particular, purely computational analysis of the reflected laser light of the laser light flash in a broad received reflection spectrum. In this case, the polarizer may be arranged on the emitter unit, as well as on the receiver unit, or on both of these units.

It is furthermore advantageous if the optical sensor system of an inventive assembly module features an optical system for broadening the Gaussian distribution of the intensity of the emitted laser light flash in order to supply the boundaries of the detection area with sufficiently high intensity. In other words, a dispersion of the emitted laser light flash is preferably homogenized. Since the laser light flash is emitted into the detection area, the outer boundaries for this monitoring step or this consistency step can be defined. These outer boundaries preferably coincide with the outer boundaries of the predefined actuation area, which was already described above and is smaller than the detection area. These outer boundaries serve for making a distinction between an intended actuation and an unintended actuation. Due to the homogenization of the Gaussian distribution toward these edges or these boundaries, it is ensured that this also functions in a strictly distinguished fashion at the edges or the boundaries of the actuation area during the detection of the three-dimensional information by means of the laser light flash. In this respect, it should be noted that this broadening of the laser light beam is purely geometrical with respect to the homogenization effect. The width of the frequency peak is explicitly not broadened in this case.

Another advantage can be attained if the optical sensor system of an inventive assembly module has a cylindrical or essentially cylindrical structural shape. This results in a particularly compact design that can be very easily arranged in or on the vehicle. For example, the alignment of the cylinder axis of this structural shape preferably correlates with the emitting direction of the laser light flash or other emitting directions. As a result, the desired and advantageous alignment of the assembly module for the inventive effect can be easily and definitely realized during the assembly of the assembly module and therefore also of the optical emitter unit.

It is likewise advantageous if the optical sensor system of an inventive assembly module is designed for a superposition, particularly a complete superposition, of the detection area and/or the actuation area with the emitted laser light flash. This refers to the entire detection area or preferably only the entire actuation area being superimposed with the laser light flash. This ensures that the inventive quality of the 3D information in the form of additional distance information is respectively available for the entire detection area or the entire actuation area. In this context, it should be once again noted that a corresponding emitter unit of the sensor system preferably provides a conical aperture for the emission of the laser light flash. This cone of light in the form of a volumetric extent accordingly also superimposes an associated volumetric extent of an actuation volume or the actuation area and of a detection volume or the detection area.

It is furthermore advantageous if the optical sensor system of an inventive assembly module features a control device with an emitter unit for the emission of the laser light flash, wherein the emitter unit is aligned such that its emitting direction is acutely angled relative to the horizontal line, particularly with an angle greater than about 30°. This angle particularly is directed downward. Since laser light flashes with high intensity are typically used for such embodiments, this downward alignment is associated with a safety gain. In addition, it is thereby also possible to use energies, which with respect to their intensity define a laser class that would cause damages to the eye of a user. Due to the downward alignment of the emitting direction, the risk of the laser light entering the human eye during the use of such an optical system can be significantly reduced. The emitting direction is simultaneously directed at an actuation area that preferably is respectively arranged on the ground or in the region of the ground or slightly above the ground. If a side door is monitored, corresponding optical monitoring may take place in the region of the door handle.

It is furthermore advantageous if the optical sensor system of an inventive assembly module features a control device for determining the distance of the user from the optical sensor system by evaluating the time difference between the emission of the light flash and the detection of the reflection of the laser light flash by the user. The aforementioned TOF determination particularly is used for this purpose. The point, at which the laser light flash is emitted, is initially determined in this case. This is followed by determining the point, at which the reflection of the laser light flash by the user is perceived by a corresponding receiver unit of the optical system. The time difference between these two points can ultimately be determined. The time difference is correlated with the speed of light and thereby used for determining the actual distance from the user. In this way, three-dimensional information with respect to the geometric positioning of the user within the detection area or within the actuation area can be obtained. It is thereby even possible, in particular, to measure the exact coordinates of the user or of the body part of the user in these three dimensions.

In an inventive assembly module, it is furthermore advantageous if the signal is triggered in order to carry out at least one of the following actions on the motor vehicle:
opening and/or closing the tailgate of the vehicle
opening and/or closing a sliding door of the motor vehicle
opening and/or closing a side door of the motor vehicle
opening and/or closing a window of the motor vehicle
opening and/or closing the engine hood of the motor vehicle
opening and/or closing the fuel tank cap of the motor vehicle
activating and/or deactivating an auxiliary heating system of the motor vehicle
activating and/or deactivating a window heating system of the motor vehicle
activating and/or deactivating a light function of the motor vehicle
folding in and/or folding out the side mirrors of the motor vehicle
activating and/or deactivating an alarm system of the motor vehicle
adjusting a user-specific setting in the motor vehicle, particularly the setting of the driver's seat
retracting and/or extending a trailer hitch.

However, the preceding list is not conclusive. The respective object, i.e. the tailgate, the sliding door, the side door, the window, the engine hood or a corresponding sliding roof, preferably can be opened and/or closed automatically. For example, the user of the vehicle can now actively open or close the tailgate of the vehicle with a corresponding gesture. According to the invention, a sliding door or side door of the vehicle also can be opened and closed automatically and therefore in a motor-driven fashion with a thusly designed assembly module. This applies analogously to a motor-driven movement of the window, the sliding roof, the engine hood or the fuel tank cap. An action may naturally also be assigned to other functions of the vehicle. This may concern, e.g., controlling or regulating the activation and deactivation of an auxiliary heating system. In winter, a corresponding window heating system also can already be activated from outside the vehicle. Even a light function providing improved illumination in the area, in which the user is currently located, can be activated or deactivated with an inventive assembly module. The side mirrors of the vehicle can be automatically folded in and folded out with an inventive assembly module before or after the vehicle is parked. Furthermore, the alarm system of the motor vehicle can be controlled with the aid of an inventive assembly module. Last but not least, user-specific settings such as, e.g., the setting of the driver's seat can be adjusted beforehand by means of an inventive assembly module.

It may furthermore be advantageous if the optical sensor system of an inventive assembly module features a control device with a detection unit for carrying out step a), an emitter unit for carrying out step b), a receiver unit for carrying out step c) and an evaluation unit for carrying out step d). In this way, all steps of the method to be executed by an inventive optical sensor system can be carried out with corresponding units of the control device. Individual units naturally may also be combined. For example, the receiver unit and the detection unit may be combined and realized in the form of a single sensor unit. A double sensor unit for different types of light may also be provided.

An assembly module according to the preceding paragraph can be enhanced to the effect that the emitter unit features at least one laser light source for the emission of the laser light flash, particularly for the successive pulsed emission of a plurality of laser light flashes. In this way, an additional improvement of the inventive assembly module is achieved because it is now also possible to acquire detailed information with respect to the three-dimensional movement of the user relative to the actuation area rather than only a single position. The laser light flashes may be emitted, e.g., by laser diodes in this case. In this context, each corresponding laser light source may feature one or more laser diodes. The pulsed emission preferably takes place with a frequency of 20 or more laser light flashes per second.

It may furthermore be advantageous if the at least one laser light source is arranged adjacent to the receiver unit. If several laser light sources are provided, all these laser light sources particularly are uniformly distributed around the receiver unit. Homogenized illumination can thereby be achieved. The emitter unit and the receiver unit are preferably arranged in close vicinity of one another such that the angle between the emitting direction and the receiving direction of the emitter unit and the receiver unit can be neglected in the above-described TOF measurement.

It may furthermore be advantageous if the emitter unit of an inventive assembly module is designed for emitting the laser light flash along at least two emitting directions that meet in a focal point arranged within the detection area, particularly within the actuation area. Accordingly, these laser light flashes respectively can be individually emitted with reduced energy such that the energy required for the desired reflection is only reached in the focal point within the detection area. This focal point may be realized punctiform or in the form of a volumetric element within the detection area. Such a volumetric element of the focal point preferably is smaller than or equal to the actuation area in the form of an actuation volume.

It is likewise advantageous if the laser light flash is in an inventive assembly module emitted into the actuation area that is smaller than the detection area and realized within the detection area. In this way, the actuation area is correlated with the laser light flash such that no precise three-dimensional monitoring with the laser light flash any longer has to take place in unnecessary regions of the detection area. This particularly reduces the energy demand because the use of the laser light flash is now restricted to the required actuation area only.

The present invention likewise pertains to a method for triggering a signal in order to carry out an action on a motor vehicle, wherein said method features the following steps:
a) monitoring a detection area located outside the motor vehicle in order to detect the proximity of a user
b) emitting a light flash within the detection area,
c) detecting a reflection of the laser light flash by the user, and
d) triggering a signal for carrying out an action on the motor vehicle in case the user is detected in a predefined actuation area within the detection area.

An inventive method is particularly intended for the operation of an inventive assembly module. Accordingly, an inventive method provides the same advantages as those explicitly described above with reference to an inventive assembly module.

Other advantages, characteristics and details of the invention can be gathered from the following description, in which exemplary embodiments of the invention are described in greater detail with reference to the drawings. In this respect, the characteristics disclosed in the claims and the description may respectively be essential to the invention individually or in arbitrary combination. In the schematic drawings:

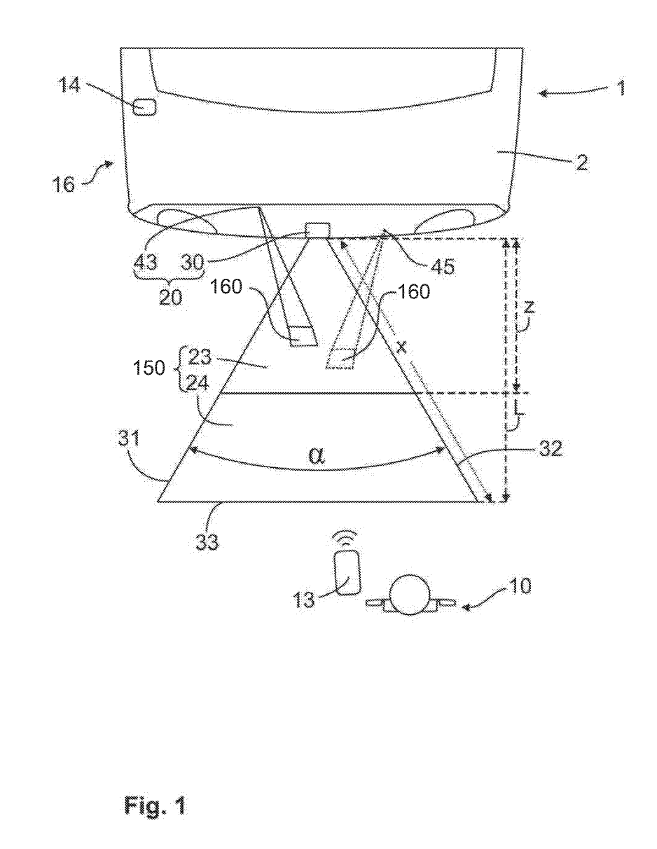

FIG. 1 shows a top view of a tail region of a motor vehicle with an inventive assembly module and an inventive authentication system,

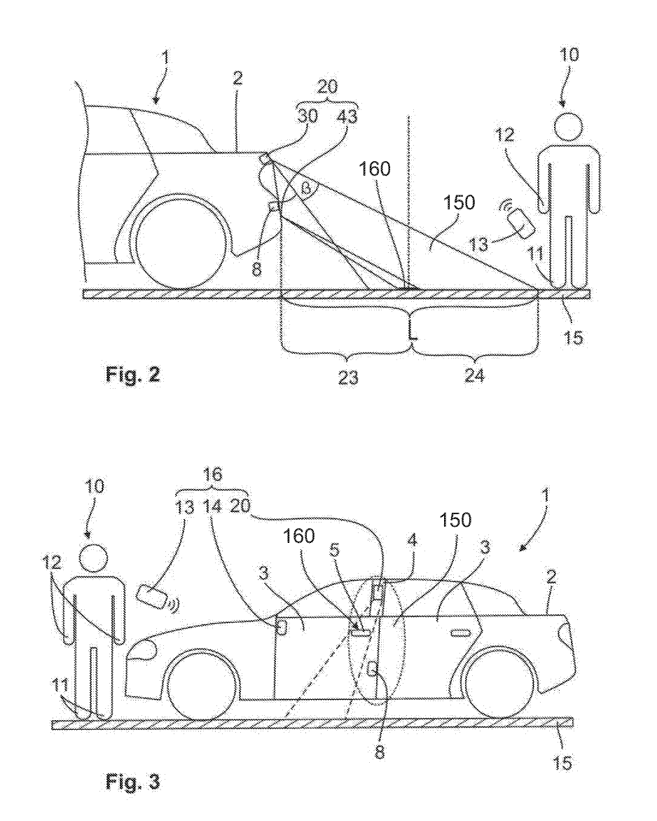

FIG. 2 shows the tail region of FIG. 1 in the form of a side view,

FIG. 3 shows a side view of a lateral area of a motor vehicle with an inventive assembly module and an inventive authentication system,

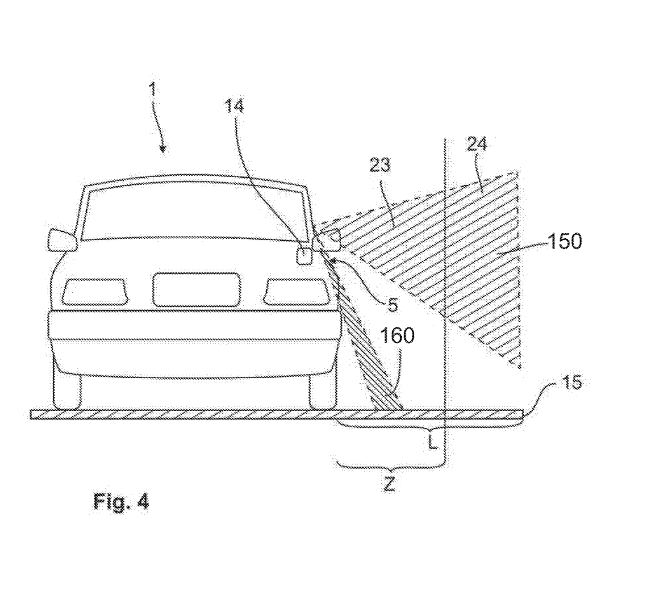

FIG. 4 shows the assembly module of FIG. 3 in the form of another side view,

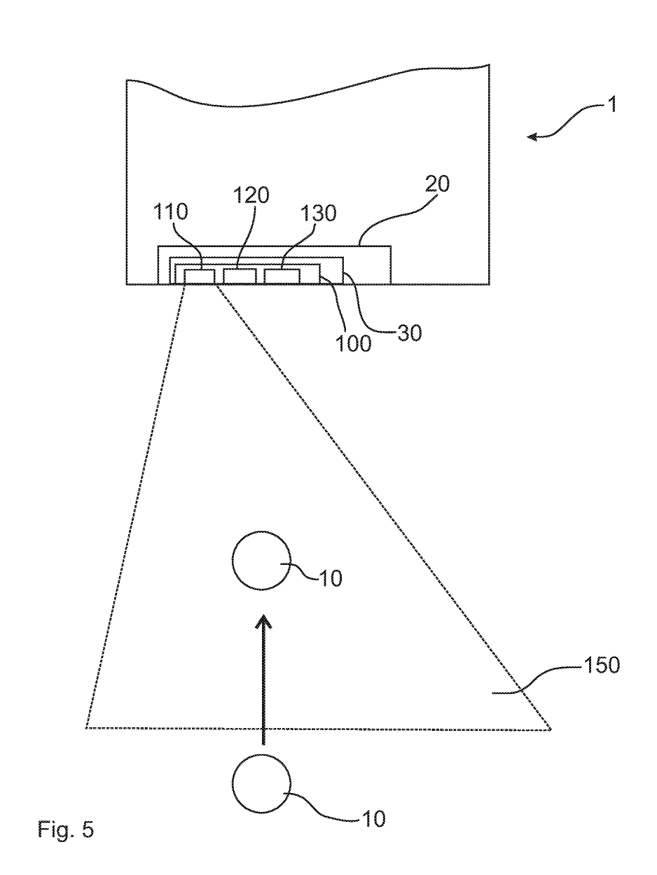

FIG. 5 shows an embodiment of an inventive assembly module,

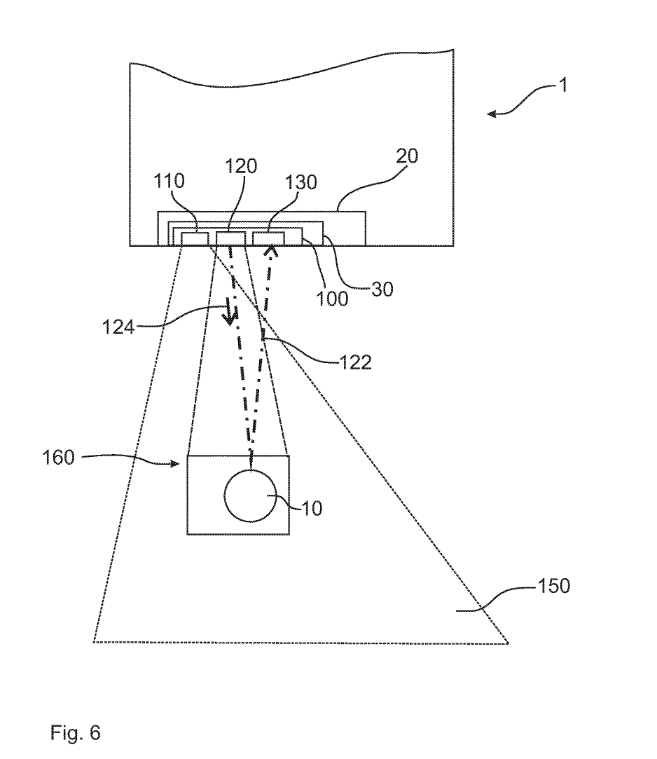

FIG. 6 shows the embodiment of FIG. 5 with a user located within the actuation area,

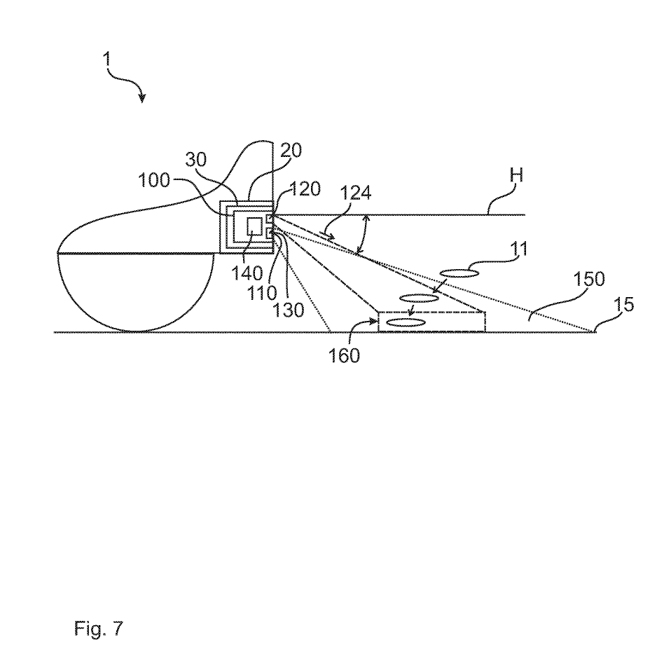

FIG. 7 shows another embodiment of an inventive assembly module,

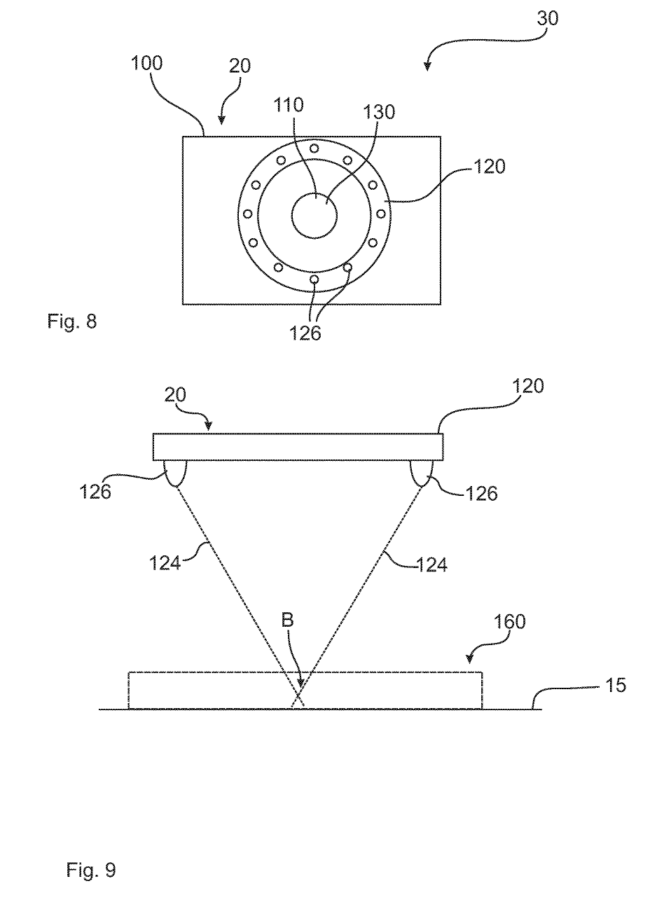

FIG. 8 shows another embodiment of an inventive assembly module, and

FIG. 9 shows yet another embodiment of an inventive assembly module.

Elements with identical function and mode of action are identified by the same reference symbols in the figures.

FIGS. 1 and 2 on the one hand and FIGS. 3 and 4 on the other hand respectively show how an inventive assembly module 20 and an inventive authentication system 16 are used in a motor vehicle 1. FIGS. 1 and 2 show the use in a tail region of a motor vehicle 1 with a tailgate 2. The optical sensor system 30 of the assembly module 20 is arranged in the region of the tailgate 2, e.g. in a handle of the tailgate 2. The optical sensor system 30 defines a detection area 150 that lies outside the motor vehicle 1. The optical sensor system 30 continuously monitors the detection area 150 while the motor vehicle 1 is parked. When a user 10, who is still illustrated outside the detection area 150 in FIGS. 1 and 2, approaches the vehicle 1 and the optical sensor system 30 with an ID transmitter 13, the user 10 reaches the detection area 150. Once the user 10 is detected in the detection area 150, a signal for starting an authentication check is preferably triggered.

Since the optical sensor system 30 detects that a user 10 approaches the motor vehicle 1 and a signal for starting an authentication check is triggered in case the user 10 is detected in the detection area 150, no activity of the user is required in order to initiate the authentication check. Consequently, the user 10 does not have to hold the ID transmitter 13 in one hand, but rather can simply carry along the ID transmitter 13, for example in a pocket. The authentication check being carried out therefore is a passive keyless entry check.

Since an optical sensor system 30 monitors the detection area 150, it can on the one hand be ensured that the signal for starting the authentication check is triggered before the user 10 reaches the motor vehicle 1. In this respect, the authentication check will usually be completed before the user 10 has moved closer to the motor vehicle 1 than the actuation area 160. On the other hand, the detection area 150 is limited to a predefined space section that, for example, only comprises a few m² in a top view such that the signal for starting the authentication check only is rarely triggered. In this way, the signal for starting the authentication check can be timely and purposefully triggered.

In a top view, the detection area 150 has two sides 31, 32 that converge toward the optical sensor system 30. The detection area 150 also has a base 33 that defines the detection area 21 on the side of the detection area 21 lying opposite of the optical sensor system 30. The detection area 21 ends at the base 33. The base 33 is realized straight. The two sides 31, 32 include an angle α. Since the detection area 150 is tapered in the direction of the motor vehicle 1, the timely yet rare triggering of the signal for starting an authentication can be achieved particularly well.

In FIG. 1, the angle α lies between 30° and 60°. In this way, a user 10, who laterally walks past the motor vehicle 1, is prevented from reaching the detection area 150. A length L resulting from the distance of the base 33 from the optical sensor system 30 amounts to 1.5 m. The length L and the angle α also result in the maximum distance x of a point of the detection area 150 from the optical sensor system 30. The detection area 150 is defined by the chosen parameters such that only little electric power is required for monitoring the detection area 150. According to FIG. 2, the detection area 150 ends at a ground area 15, on which the motor vehicle 1 is parked. The detection area 150 therefore has the shape of an oblique truncated cone. An angle β illustrated in FIG. 2 corresponds to an angle of the detection area 21 in a side view. The angle α is presently chosen unequal to the angle β such that the detection area 150 is realized elliptical.

Another option for only requiring little electric power consists of dividing the detection area 150 into a far zone 24 and a near zone 23, wherein the near zone 23 is spaced apart from the sensor system 30 by a shorter distance than the far zone 24. When the user 10 initially reaches the far zone 24, the optical sensor system 30 detects that an object is located in the far zone 24. The optical sensor system 30 furthermore checks if the object has a predefined size. If the object has the predefined size and if the object moves into the near zone 23 of the detection area 150, it is furthermore determined in the near zone 23 if the object approaches the optical sensor based on a measurement of the distance of the object from the optical sensor 50. If this is the case, the user 10 is detected and a signal for starting an authentication check between the ID transmitter 13 and an access control system 14 of the motor vehicle 1 is triggered.

This signal causes the access control system 14 to transmit a wake-up signal to the ID transmitter 13. The ID transmitter 13 subsequently transmits an authentication code to the access control system 14. The access control system 14 compares the authentication code with a stored code. If the two codes correspond, the authentication is successful and an unlocking signal is triggered. This unlocking signal may consist of an unlocking signal for all doors of the motor vehicle 1 or of an unlocking system for the tailgate 2 only.

FIGS. 1 and 2 furthermore show the first actuation area 160. After a successful authentication, the optical sensor system 30 monitors the first actuation area 160. An operating signal is triggered if the user 10 now carries out a predefined movement in the first actuation area 160 such as, for example, stepping into the first actuation area 160 with one foot 11 for a certain period of time and within a predefined actuation period. The operating signal consists of a signal for opening the tailgate 2. In this respect, the door lock 8 of the tailgate 2 may merely be unlocked such that the tailgate opens slightly due to the pressure of a seal. On the other hand, it would also be conceivable to simultaneously activate a motor-driven opening aid with the operating signal such that the tailgate 2 opens completely.

The actuation area 160 is preferably visualized on the ground area 15. In this embodiment, a first display element 43, which visualizes the actuation area 160 for the user 10, is provided for this purpose. The first display element 43 may emit visible light. The first display element 43 is activated after a successful authentication. In FIGS. 1 and 2, the first actuation area 160 lies within the near zone 23 of the detection area 150. The actuation area 160 has smaller spatial dimensions than the detection area 150.

The first actuation area 160 may be the only actuation area. In FIG. 1, an optional second actuation area 160 is additionally illustrated with broken lines. In this case, a user 10 has to carry out a predefined movement in both actuation areas 160 within a predefined actuation period in order to trigger the operating signal. A second display element 45 of the assembly module 20 serves for visualizing the second actuation area 160.

FIGS. 3 and 4 show another exemplary embodiment using the inventive assembly module 20. Unless mentioned otherwise below, the mode of action and function of the assembly module 20 illustrated in FIGS. 3 and 4 correspond to the mode of action and function of the assembly module 20 illustrated in FIGS. 1 and 2. The assembly module 20 is arranged in a B-pillar on one side of the motor vehicle in FIGS. 3 and 4. The detection area 150 monitors if a user approaches a side door 3 of the motor vehicle 1. The predefined movement for triggering the operating signal may consist of a predefined movement with one hand 12 of the user 10 in the region of the door handle 5.

In contrast to the exemplary embodiment in FIGS. 1 and 2, the complete detection area 150 located outside the motor vehicle 1 is positioned above the ground area 15 in FIGS. 3 and 4. The detection area 150 has a plane base. The actuation area 160 of the exemplary embodiment in FIGS. 3 and 4 includes the area of the door handle 5. The only actuation area 160 lies outside the detection area 150.

FIG. 5 shows an embodiment of an inventive assembly module 20 that is arranged in a motor vehicle 1 on the rear side. This assembly module 20 is equipped with a control device 100 that forms part of an optical sensor system 30. In this embodiment, the control device 100 features a detection unit 110, an emitter unit 120 and a receiver unit 130.

The detection unit 110 is capable of monitoring the rearward detection area 150 arranged behind the motor vehicle 1. The detection unit 110 may feature, e.g., a photosensor for this purpose. Additional emitter units 120 may also be provided for monitoring the detection area with artificial light in order to achieve a corresponding independence from the ambient lighting. Pulsed light flashes also may already be used at this point.

According to the invention, an emitter unit 120 for the emission of laser light flashes 122 is additionally provided. The steps of the method to be executed by means of an inventive assembly module 20 are described in greater detail below with reference to FIGS. 5 and 6.

FIG. 5 shows how a user 10 enters the detection area 150, e.g. with a body part or completely. Since the detection area 150 essentially is continuously monitored by the detection unit 110, the optical sensor system 30 detects this motion of the user 10 with the aid of the control device 100. An emission of the laser light flash 122 can now take place, preferably in the form of a two-stage process, in order to obtain additional information on the position of the user 10. In this way, the position of the user 10 can be correlated with an actuation area 160. In this case, the laser light flash 122 is preferably emitted with an emitting direction 124 that overlaps with the actuation area 160 or exactly illuminates this actuation area with homogenous intensity distribution.

According to FIG. 6, the laser light flash 122 is at least partially reflected by the user 10. This reflected light of the laser light flash 122 can be received by the receiver unit 130 and evaluated. The evaluation is carried out, in particular, based on the so-called TOF measurement such that additional distance information is now available for positioning the user 10 more accurately in correlation with the actuation area 160.

Since the user 10 in FIG. 6 has now been detected within the actuation area 160, a signal for carrying out an action on the motor vehicle 1 can be triggered. This action may consist, e.g., of opening the tailgate or a lateral sliding door of the motor vehicle 1.

FIG. 7 schematically shows another embodiment of an inventive assembly module 20 in the form of a side view. This assembly module is equipped with an optical system 30 that once again features a control device 100. According to this figure, the emitter unit 120 is arranged above the detection unit 110, wherein the detection unit 110 is in this case also functionally combined with the receiver unit 130. The control device 100 furthermore features an evaluation unit 140 in this embodiment in order to carry out the individual steps of the method, particularly the evaluation.

According to FIG. 7, the precise determination of the position with the aid of the laser light flash 122 now makes it possible to monitor volumetric information with respect to the detection area 150 or the actuation area 160. This figure shows the movement of a foot 11 of a user 10. If the foot 11 of the user 10 moves along the three positions shown, it initially penetrates the volume of the detection area 150. The emission of the pulsed laser light flashes 122 along the emitting direction 124 is not carried out until this point is reached, preferably in a two-stage process, and stops once it is detected that the foot 11 of the user 10 is now located in the volume of the actuation area 160. The signal for carrying out an action on the motor vehicle can now be triggered.

FIG. 7 furthermore shows that the horizontal line H and the emitting direction 124 of the laser light flash 122 include an angle that acutely points downward. In this way, downward monitoring can be carried out from above such that the risk of injuries to the human eye preferably can be completely eliminated.

FIG. 8 shows an embodiment of an inventive assembly module 20, in which the emitter unit 120 features a plurality of laser light sources 126. These individual laser light sources 126 are annularly and uniformly distributed around the receiver unit 130 that also forms the detection unit 110 in this case. This results in a particularly homogenous light distribution referred to the emission of the laser light flash 122. Due to the reduction of the distance between the emitter unit 120 and the receiver unit 130, the angle can simultaneously be neglected in the subsequent evaluation by means of the TOF method.

FIG. 9 shows another embodiment of the inventive assembly module 20. In this case, several laser light sources 126 are provided at a distance from one another in order to form the emitter unit 120. This results in several emitting directions 124, in this case two schematically illustrated emitting directions that have a focal point B within the actuation area 160. Consequently, the individual laser light sources 126 can be operated with reduced energy because the corresponding energy density for the desired reflection on a user 10 is only made available in the focal point B. In addition to the energy demand, this also reduces the risk of injuries, e.g. of the human eye, because the high energy density is only reached in the focal point B. In this context, it should be noted that the focal point B may also be realized in the form of a volumetric element within the actuation area 160.

The preceding explanation of embodiments exclusively describes the present invention in the context of examples. Individual characteristics of the embodiments naturally may, if technically sensible, be freely combined without deviating from the scope of the present invention.

### LIST OF REFERENCE SYMBOLS

1 Motor vehicle
2 Tailgate
3 Side door
4 B-pillar
5 Door handle
8 Door lock
10 User
11 Foot
12 Hand
13 ID transmitter
14 Access control system
15 Ground area
16 Authentication system
20 Assembly module
23 Near zone
24 Far zone
30 Optical sensor system
31 Side of detection area
32 Side of detection area
33 Base
43 First display element
45 Second display element
100 Control device
110 Detection unit
120 Emitter unit
122 Laser light flash
124 Emitting direction
126 Laser light source
130 Receiver unit
140 Evaluation unit
150 Detection area
160 Actuation area
α Angle between two sides of detection area
β Angle
H Horizontal line
B Focal point
L Length
x Maximum distance of a point of the detection area
z ##

1-19. (canceled)

20. An assembly module for a motor vehicle with an optical sensor system that is suitable for
a) monitoring a detection area located outside the motor vehicle in order to detect the proximity of a user,
b) emitting a laser light flash within the detection area,
c) detecting a reflection of the laser light flash by the user, and
d) triggering a signal for carrying out an action on the motor vehicle in case the user is detected in a predefined actuation area within the detection area.

21. The assembly module according to claim 20,
wherein
the optical sensor system is designed for triggering a signal for starting an authentication check between an ID transmitter and an access control system of the motor vehicle if the user is detected in the detection area and for only carrying out steps b) through d) if the authentication result is positive.

22. The assembly module according to claim 20,
wherein
the optical sensor system is designed for inhibiting steps b) through d) if no user has been detected in the detection area.

23. The assembly module according to claim 20,
wherein
the optical sensor system features an emitter unit for the emission of the laser light flash with a wavelength in the infrared range, particularly with a wavelength in the range of 905 nm +− about 10 nm.

24. The assembly module according to claim 20,
wherein
the optical sensor system features at least one optical filter, particularly an infrared filter, for at least optically filtering out the emitted laser light flash or the reflection of the laser light flash.

25. The assembly module according to claim 20,
wherein
the optical sensor system features at least one polarizer for at least polarizing the emitted laser light flash or the reflection of the laser light flash.

26. The assembly module according to claim 20,
wherein
the optical sensor system features an optical system for broadening the Gaussian distribution of the intensity of the emitted laser light flash in order to supply the boundaries of the detection area with sufficiently high intensity.

27. The assembly module according to claim 20,
wherein
the optical sensor system has a cylindrical or essentially cylindrical structural shape.

28. The assembly module according to claim 20,
wherein
the optical sensor system is designed for a superposition, particularly a complete superposition, of at least the detection area or the actuation area with the emitted laser light flash.

29. The assembly module according to claim 20,
wherein
the optical sensor system features a control device with an emitter unit for the emission of the laser light flash, wherein the emitter unit is aligned such that its emitting direction is acutely angled relative to the horizontal line, particularly with an angle greater than about 30°.

30. The assembly module according to claim 20,
wherein
the optical sensor system features a control device for determining the distance of the user from the optical sensor system by evaluating the time difference between the emission of the laser light flash and the detection of the reflection of the laser light flash by the user.

31. The assembly module according to claim 20,
wherein
the signal is triggered in order to carry out at least one of the following actions on the motor vehicle:
at least opening or closing the tailgate of the motor vehicle
at least opening or closing a sliding door of the motor vehicle
at least opening or closing a side door of the motor vehicle
at least opening or closing a window of the motor vehicle
at least opening or closing the engine hood of the motor vehicle
at least opening or closing the fuel tank cap of the motor vehicle
at least activating or deactivating an auxiliary heating system of the motor vehicle
at least activating or deactivating a window heating system of the motor vehicle
at least activating or deactivating a light function of the motor vehicle
at least folding in or folding out the side mirrors of the motor vehicle
at least activating or deactivating an alarm system of the motor vehicle
adjusting a user-specific setting in the motor vehicle, particularly the setting of the driver's seat
at least retracting or extending a trailer hitch.

32. The assembly module according to claim 20,
wherein
the optical sensor system features a control device with a detection unit for carrying out step a), an emitter unit for carrying out step b), a receiver unit for carrying out step c) and an evaluation unit for carrying out step d).

33. The assembly module according to claim 20,
wherein
the emitter unit features at least one laser light source for the emission of the laser light flash, particularly for the successive pulsed emission of a plurality of laser light flashes.

34. The assembly module according to claim 33,
wherein
the at least one laser light source is arranged adjacent to the receiver unit.

35. The assembly module according to claim 20,
wherein
the emitter unit is designed for emitting the laser light flash along at least two emitting directions that meet in a focal point arranged within the detection area, particularly within the actuation area.

36. The assembly module according to claim 20,
wherein
the laser light flash is emitted into the actuation area that is smaller than the detection area and realized within the detection area.

37. A method for triggering a signal in order to carry out an action on a motor vehicle, wherein said method features the following steps:
a) monitoring a detection area located outside the motor vehicle in order to detect the proximity of a user
b) emitting a laser light flash within the detection area,
c) detecting a reflection of the laser light flash by the user, and
d) triggering a signal for carrying out an action on the motor vehicle in case the user is detected in a predefined actuation area within the detection area.

38. The method according to claim 37,
wherein
it is intended for the operation of an assembly module for a motor vehicle with an optical sensor system that is suitable for
a) monitoring a detection area located outside the motor vehicle in order to detect the proximity of a user,
b) emitting a laser light flash within the detection area,
c) detecting a reflection of the laser light flash by the user, and
d) triggering a signal for carrying out an action on the motor vehicle in case the user is detected in a predefined actuation area within the detection area.
